(19) United States
(12) Patent Application Publication
(10) Pub. No.: US 2006/0044784 A1
(43) Pub. Date: Mar. 2, 2006

(54) Ornamental light string

(76) Inventor: Ti-Fen Lee, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/925,947

(22) Filed: Aug. 26, 2004

(51) Int. Cl. F21V 33/00

(52) U.S. Cl. 362/86; 362/253; 362/808

(57) ABSTRACT

An ornamental light string includes a light-emitting device, a sounding device, a motion device, a drive circuitry module, a light sensor and a switch. The light sensor detects the light to control the light-emitting device and the switch enables or disables the drive circuitry module to control the sounding device and the motion device so as to achieve the animated and electricity saving functions and extend the using life of the ornamental light string.

### BACKGROUND OF THE INVENTION

1. Field of the Invention

The present invention relates to an ornamental light string, and specifically to an ornamental light string which automatically turns on or off a light-emitting device, allows for sounds to be played and controls the movement of a figurine.

2. Description of the Prior Art

Reference is made to FIG. 1, which is a schematic view of a conventional ornamental light string. An ornamental light string includes a plug 11a, an electric wire 12a, a bulb base 21a electrically connected to the electric wire 12a and a bulb 22a installed in the bulb base 21a. Moreover, the ornamental light string further comprises a connector 3a, an extended electric wire 31a, and a light-emitting unit 4a, wherein one end of the extended electric wire 31a connects with the connector 3a and the other end of the extended electric wire 31a connects with the light-emitting unit 4a.

The ornamental light string of prior art has the following drawbacks:

1. It is inconvenient to manually turn on or off the ornamental light string;

2. When there is enough light in the surrounding environment, use of the ornamental light string continuously is wasteful of electrical power and reduces the life of the ornamental light string; and

3. The light bulbs cannot be changed, so for every different celebration the consumer must purchase a different light string.

The inventor of the present invention recognizes that the above drawbacks should be corrected and special effort has been paid to research this field. The present invention is presented with reasonable design and good effect to resolve the above-mentioned drawbacks.

### SUMMARY OF THE INVENTION

Accordingly, the primary object of the present invention is to provide an ornamental light string, in which a light sensor is used to detect the magnitude of the light so as to enable or disable a light-emitting drive circuitry which automatically turns on or off a light-emitting device. Therefore, when there is not enough light in the surrounding environment, the light sensor automatically sends an enabling electric signal to the light-emitting drive circuitry to turn on the light-emitting device. Conversely, when there is enough light in the surrounding environment, the light sensor automatically sends a disabling electric signal to the light-emitting drive circuitry to turn off the light-emitting device. So, it automatically enables or disables the light-emitting drive circuitry to turn on or off the light-emitting device so as to save the electricity and to extend the life of the ornamental light string.

Another object of the present invention is to provide an ornamental light string, in which a switch enables a sounding device and a motion device to play sounds and to allow movement of figurines.

For achieving the objects stated above, the present invention provides an ornamental light string which includes a light-emitting device, a sounding device, a motion device, a light-emitting drive circuitry electrically connected with the light-emitting device for lighting the light-emitting device, a sounding drive circuitry electrically connected with the sounding device for playing sounds from the sounding device, and a motion drive circuitry electrically connected with the motion device for operating the motion device, a light-conducting module electrically connected with the light-emitting device for turning on or off the light-emitting device, a light sensor electrically connected with the light-emitting drive circuitry for detecting the magnitude of the light so as to control the light-emitting drive circuitry, a switch electrically connected with the sounding drive circuitry and the motion drive circuitry for turning on or off the sounding device and the motion device respectively, and a modeling body.

To provide a further understanding of the invention, the following detailed description illustrates embodiments and examples of the invention, this detailed description being provided only for illustration of the invention.

### BRIEF DESCRIPTION OF THE DRAWINGS

The foregoing aspects and many of the advantages of this invention will be more readily appreciated as the same becomes better understood by reference to the following detailed description, when taken in conjunction with the accompanying drawings, wherein:

FIG. 1 is a schematic view of a conventional ornamental light string;

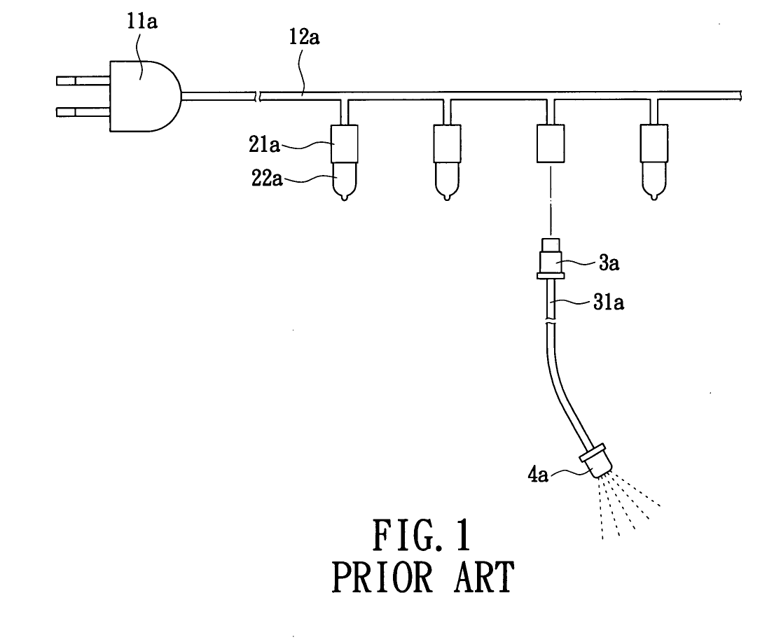

FIG. 2 is a perspective view of a first embodiment of the present invention;

FIG. 3 is a perspective view of a second embodiment of the present invention;

FIG. 4 is a perspective view of a third embodiment of the present invention;

FIG. 5 is a perspective view about sounding function of a third embodiment of the present invention;

FIG. 6 is a perspective view of a fourth embodiment of the present invention;

FIG. 7 is a circuit diagram of the light-emitting drive circuitry of the present invention;

FIG. 8 is a circuit diagram of the sounding drive circuitry of the present invention; and

FIG. 9 is a circuit diagram of the motion drive circuitry of the present invention.

### DETAILED DESCRIPTION OF PREFERRED EMBODIMENTS

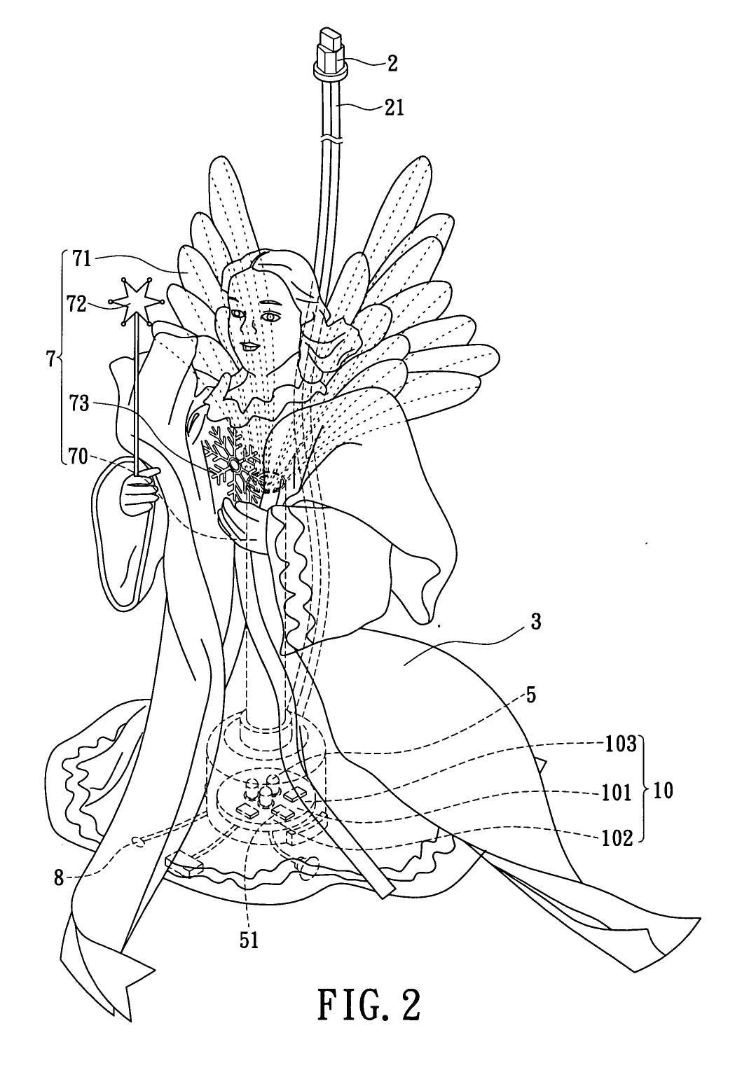

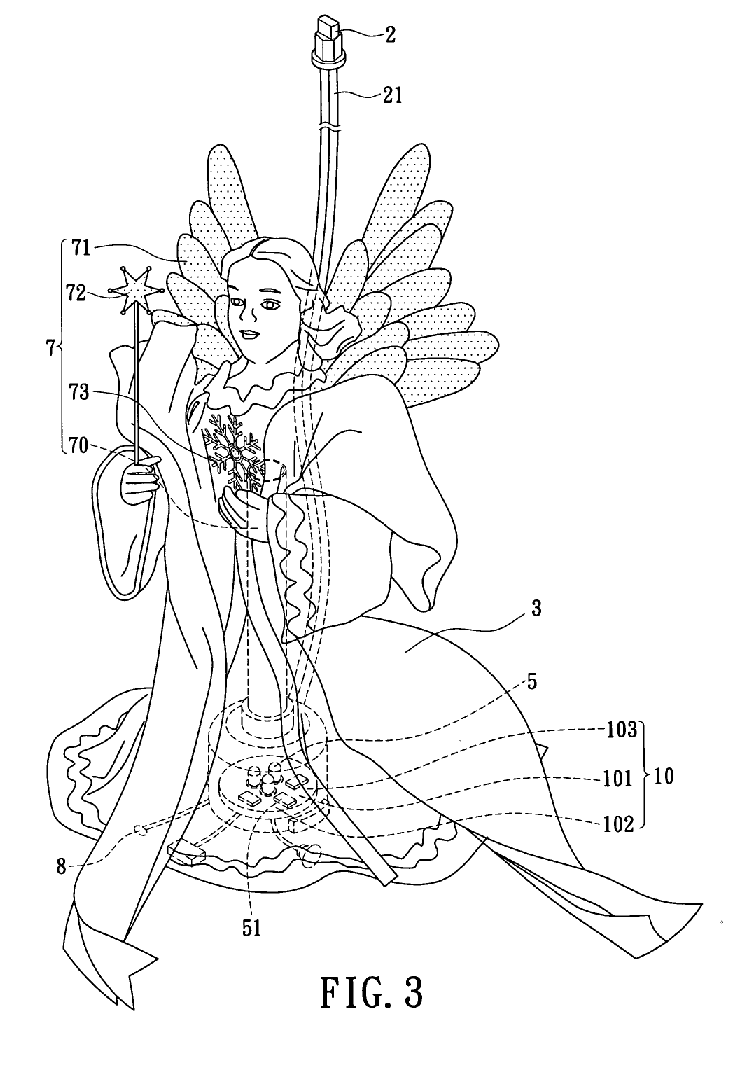

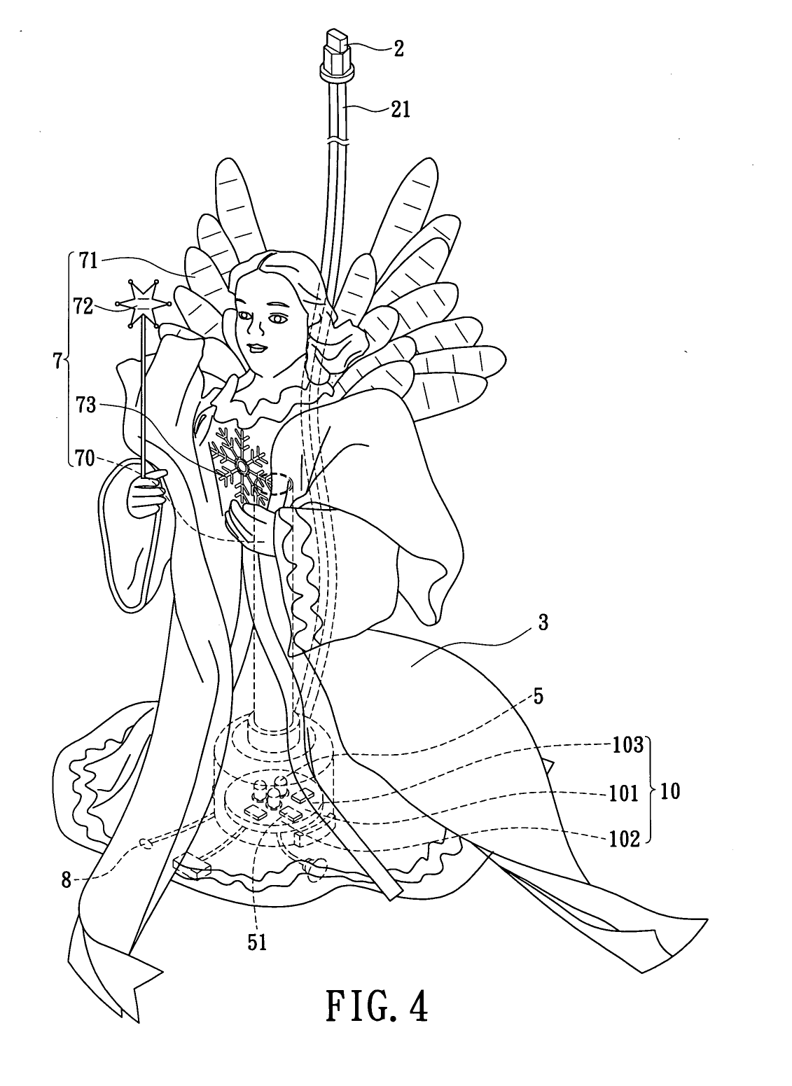

As shown in FIGS. 2 to 4, the present invention provides an ornamental light string comprising a connected terminal 2, an extended wire 21, a modeling body 3, a light-emitting device 5, a light-emitting control IC 51, a light-conducting module 7, a light sensor 8, and a drive circuitry module 10 comprising a light-emitting drive circuitry 101, a sounding drive circuitry 102 and a motion drive circuitry 103.

The modeling body 3 electrically connects to an outer source via an electric wire 21 with a connected terminal 2. The light sensor 8 electrically connected with the light-emitting drive circuitry 101 for detecting the magnitude of the light so as to automatically enable or disable the light-emitting drive circuitry 101 to light or extinguish the light-emitting device 5. When there's not enough light in the surrounding environment, the light sensor 8 automatically sends an enabling electric signal to enable the light-emitting drive circuitry 101 to turn on the light-emitting device 5. Conversely, when there is enough light in the surrounding environment, the light sensor 8 automatically sends a disabling electric signal to disable the light-emitting drive circuitry 101 to turn off the light-emitting device 5. So, it is to automatically enable or disable the light-emitting drive circuitry 101 to turn on or off the light-emitting device 5 so as to save the electricity and to extend the life of the ornamental light string.

The light-conducting module 7 comprises a first light-conducting element 71, a second light-conducting element 72, a third light-conducting element 73 and a light-conducting tube 70, wherein, two ends of the light-conducting tube 70 connect with the light-emitting device 5 and the first light-conducting element 71, the second light-conducting element 72 and the third light-conducting element 73 respectively for conducting light from the light-emitting device 5 to the first light-conducting element 71, the second light-conducting element 72 and the third light-conducting element 73.

Wherein, the first light-conducting element 71 is fiber optical bunches, an acrylic, or a polyvinyl chloride (PVC) plank; each of the second light-conducting element 72 and the third light-conducting element 73 are fiber optical bunches.

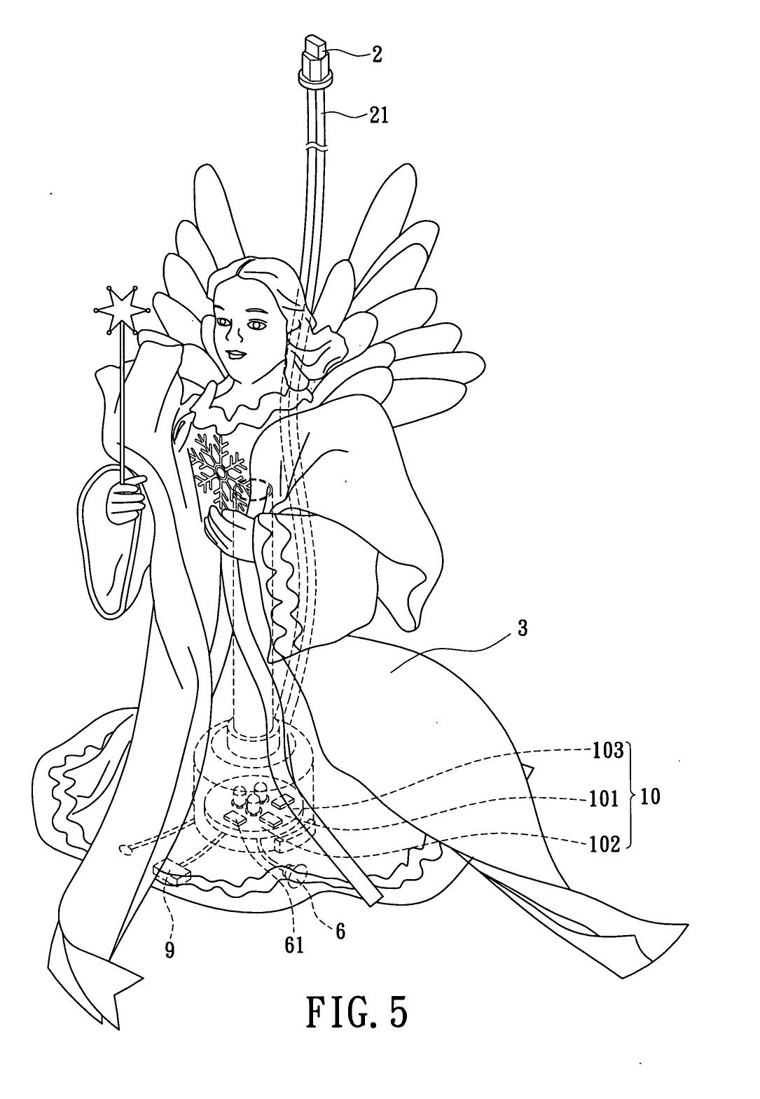

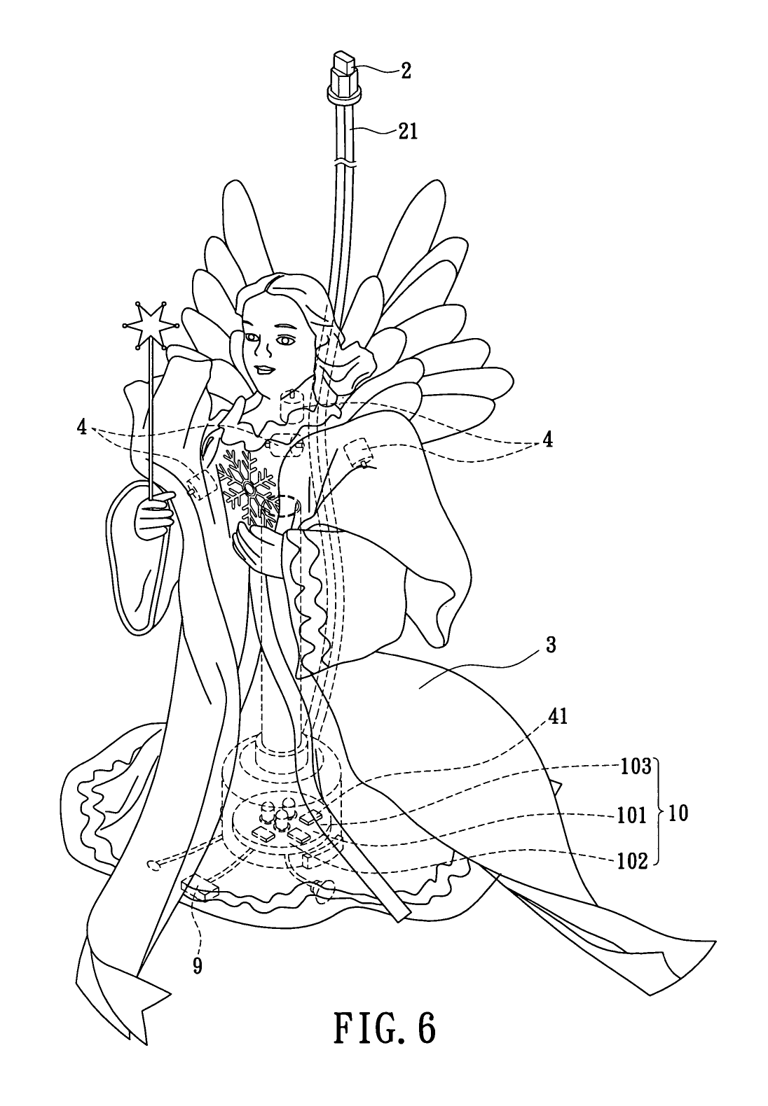

As shown in FIG. 5 and FIG. 6, the present invention provides an ornamental light string comprising a connected terminal 2, an extended wire 21, a modeling body 3, a plurality of motion devices 4, a motion control IC 41, a sounding device 6, a built-in sound IC 61, a switch 9, and a drive circuitry module 10 comprising a light-emitting drive circuitry 101, a sounding drive circuitry 102 and a motion drive circuitry 103.

The modeling body 3 electrically connects to an outer source via an electric wire 21 with a connected terminal 2. The switch 9 electrically connected with the sounding drive circuitry 102 for driving built-in sound IC 61 to play sounds. When switching the switch 9 to “ON”, the built-in sound IC 61 receives an electric signal to play sounds from the sounding device 6. Conversely, when turning the switch 9 to “OFF”, the built-in sound IC 61 doesn't receive an electric signal from the sounding device 6.

The modeling body 3 electrically connects to an outer source via an electric wire 21 with a connected terminal 2. The switch 9 electrically connected with the motion drive circuitry 103 for driving the motion control IC 41 to move the figurine. When switching the switch 9 to “ON”, the motion control IC 41 receives an electric signal to move from the motion device 4. Conversely, when switching the switch 9 to “OFF”, the motion control IC 41 doesn't receive an electric signal from the motion device 4.

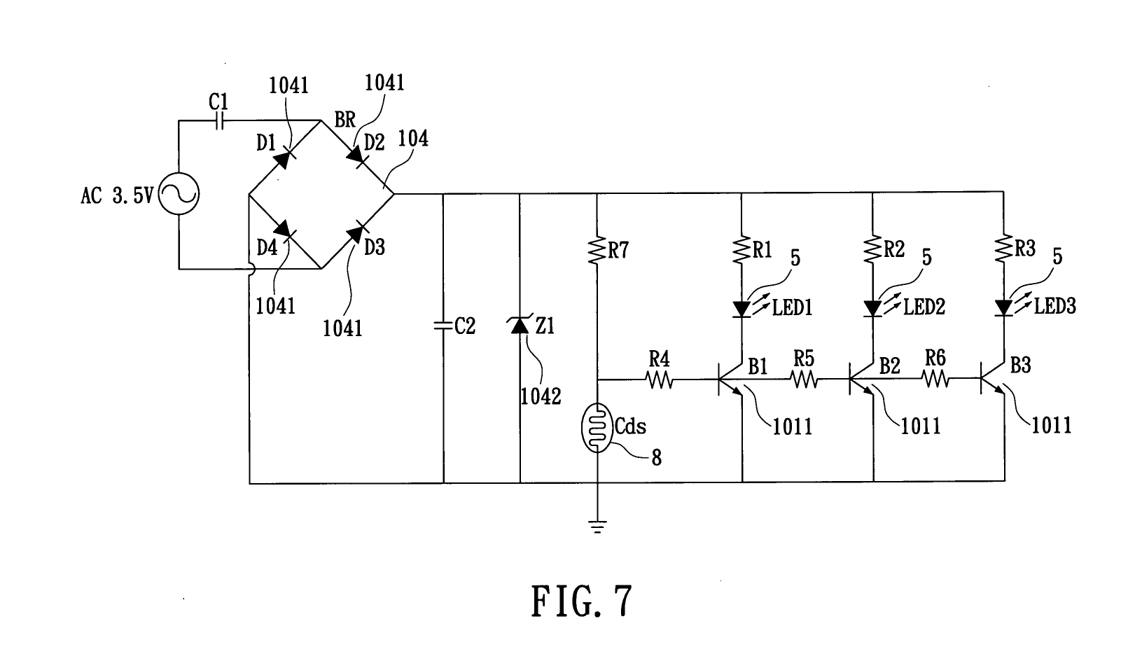

As shown in FIG. 7 which is a circuit diagram of the light-emitting drive circuitry 101 of the present invention, it provides an ornamental light string comprising a bridge rectifier 104, a Zener diode 1042, a light sensor 8, a plurality of light-emitting devices 5 and a light-emitting control IC 51 (not shown in FIG. 7).

The light-emitting drive circuitry 101 electrically connects to an outer 3.5 volts alternating current (A.C.) source. The outer 3.5 volts A.C. source connects with two ends of the bridge rectifier 104 and the other two ends of the bridge rectifier 104 connect with the filtering capacitance to rectify and filter the outer A.C. source to a direct current (D.C.) voltage and the D.C. voltage achieves a stable voltage via the Zener diode 1042.

The light sensor 8 detects the magnitude of the light. When it is dark or there's not enough light in the surrounding environment, the resistance value of the sensor 8 is increased to enable the light-emitting control IC 51 and to light and to glitter alternately the light-emitting device 5. Conversely, when it is bright or there is enough light in the surrounding environment, the resistance value of the sensor 8 is decreased to disable the light-emitting control IC 51 and to extinguish the light-emitting devices 5.

Therefore, using the light sensor 8 to detect the magnitude of the light and to automatically enable or disable the light-emitting drive circuitry 101 shall light or extinguish the light-emitting device 5 so as to achieve the electricity saving function and extend the using life of the ornamental light string.

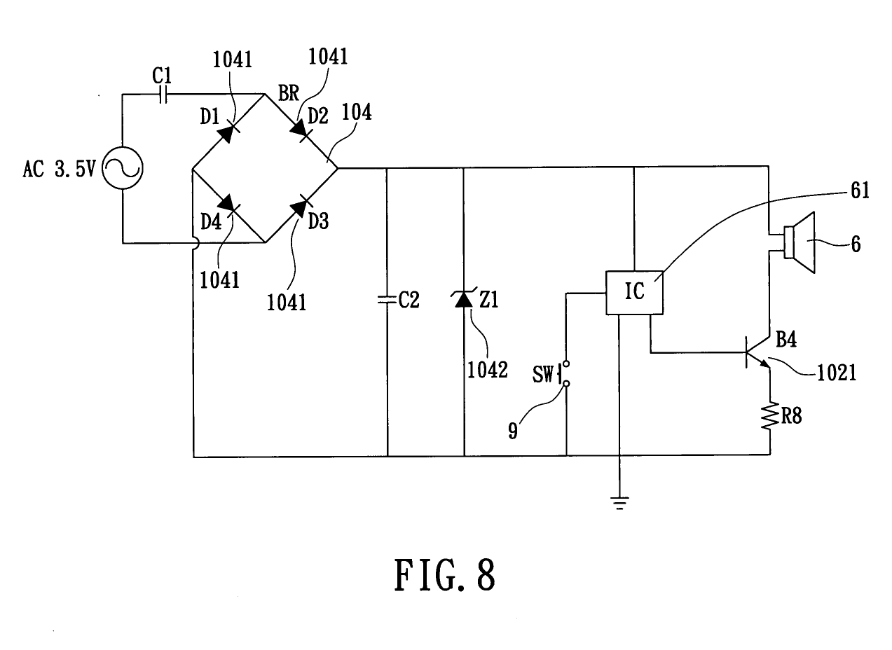

As shown in FIG. 8 which is a circuit diagram of the sounding drive circuitry 102 of the present invention, it provides an ornamental light string comprising a bridge rectifier 104, a Zener diode 1042, a switch 9, a sounding device 6, a transistor 1021 and a build-in music IC 61.

The sounding drive circuitry 102 electrically connects to an outer 3.5 volts alternating current (A.C.) source. The outer 3.5 volts A.C. source connects with two ends of the bridge rectifier 104 and other two ends of the bridge rectifier 104 connects with the filtering capacitance to rectify and filter the outer A.C. source to a direct current (D.C.) voltage and the D.C. voltage achieves a stable voltage via the Zener diode 1042.

When switching the switch 9 to “ON”, the build-in music IC 61 receives an electric signal to enable the transistor 1021 to drive the sounding device 6 to play the music. Conversely, when switching the switch 9 to “OFF”, the build-in music IC 61 will not receive any electric signal and will disable the transistor 1021 to do anything for the sounding device 6.

Therefore, using the switch 9 to drive the build-in music IC 61 to enable or disable the sounding drive circuitry 102 shall control the sounding device 6 to work or not so as to achieve animated function of the ornamental light string.

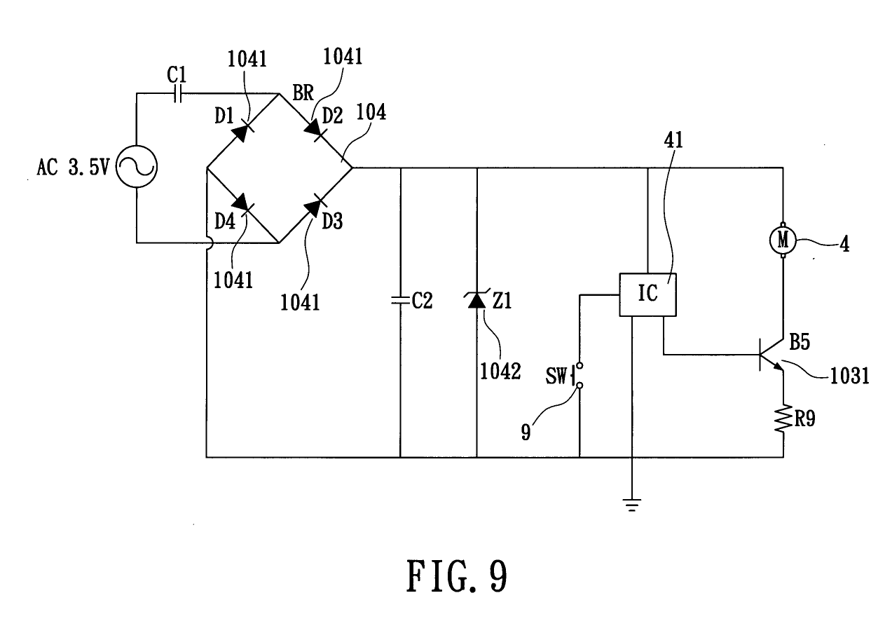

As shown in FIG. 9 which is a circuit diagram of the motion drive circuitry 103 of the present invention, it provides an ornamental light string comprising a bridge rectifier 104, a Zener diode 1042, a switch 9, a motion device 4, a transistor 1031 and a motion control IC 41.

The motion drive circuitry 103 electrically connects to an outer 3.5 volts alternating current (A.C.) source. The outer 3.5 volts A.C. source connects with two ends of the bridge rectifier 104 and other two ends of the bridge rectifier 104 connects with the filtering capacitance to rectify and filter the outer A.C. source to a direct current (D.C.) voltage and the D.C. voltage achieves a stable voltage via the Zener diode 1042.

When switching the switch 9 to “ON”, the motion control IC 41 receives an electric signal to enable the transistor 1031 to drive the motion device 4 to rotate. Conversely, when switching the switch 9 to “OFF”, the motion control IC 41 will not receive any electric signal and will disable the transistor 1031 to do anything for the motion device 4.

Therefore, using the switch 9 to drive the motion control 41 to enable or disable the motion drive circuitry 103 shall control the motion device 4 to work or not so as to achieve the vivid and lively function of the ornamental light string.

The ornamental light string of the present invention has following advantages:

1. The present invention is to provide an ornamental light string, in which a light sensor 8 is used to detect the magnitude of the light so that it can automatically enable or disable a light-emitting drive circuitry 101 to light or extinguish a light-emitting device 5 so as to achieve the convenient operation of the ornamental light string;

2. The present invention is to provide an ornamental light string, in which a light sensor 8 is used to detect the magnitude of the light so that it can automatically enable or disable a light-emitting drive circuitry 101 to light or extinguish a light-emitting device 5; especially when it is bright or there is enough light in the surrounding environment, the light sensor automatically activates an electric signal to disable the light-emitting drive circuitry to extinguish the light-emitting device so as to achieve the electricity saving function and extend the using life of the ornamental light string;

3. The present invention is to provide an ornamental light string, in which a switch 9 is used and when switching it to “ON”, the build-in music IC 61 receives an electric signal to play the music from the sounding device 6 so as to achieve the animated function of the ornamental light string; and

4. The present invention is to provide an ornamental light string, in which a switch 9 is used and when switching it to “ON”, the motion control IC 41 receives an enable electric signal to rotate the motion device 4 so as to achieve the vivid and lively function of the ornamental light string.

Although the present invention has been described with reference to the preferred embodiments thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. An ornamental light string comprising:
a light-emitting device;
a sounding device;
a motion device;
a drive circuitry module comprising:
a light-emitting drive circuitry electrically connected with the light-emitting device for driving the light-emitting device;
a sounding drive circuitry electrically connected with the sounding device for driving the sounding device; and
a motion drive circuitry electrically connected with the motion device for driving the motion device;
a light-conducting module electrically connected with the light-emitting device for receiving and displaying the light lighted from the light-emitting device;
a light sensor electrically connected with the light-emitting drive circuitry for detecting the magnitude of the light;
a switch connected with the sounding drive circuitry for enabling or disabling the sounding device; and connected with the motion drive circuitry for enabling or disabling the motion device; and
a modeling body.

2. The ornamental light string as claimed in claim 1, wherein the light-emitting device having at least two LED's.

3. The ornamental light string as claimed in claim 2, wherein the LED's are red LED's, yellow LED's, green LED's, blue LED's or white LED's.

4. The ornamental light string as claimed in claim 1, wherein the sounding device is a speaker.

5. The ornamental light string as claimed in claim 1, wherein the light-emitting drive circuitry connects an outer source via an electric wire with a connected terminal.

6. The ornamental light string as claimed in claim 1, wherein the sounding drive circuitry connects an outer source via an electric wire with a connected terminal.

7. The ornamental light string as claimed in claim 1, wherein the motion drive circuitry connects an outer source via an electric wire with a connected terminal.

8. The ornamental light string as claimed in claim 1, wherein the light sensor is a photoresistor.

9. The ornamental light string as claimed in claim 1, wherein the light-conducting module comprises:
a first light-conducting element;
a second light-conducting element;
a third light-conducting element; and
a light-conducting tube connecting with the light-emitting device and the first light-conducting element, the second light-conducting element and the third light-conducting element respectively for conducting the light lighted from the light-emitting device to the first light-conducting element, the second light-conducting element and the third light-conducting element.

10. The ornamental light string as claimed in claim 9, wherein the first light-conducting element is fiber optical bunches.

11. The ornamental light string as claimed in claim 9, wherein the first light-conducting element is an acrylic board with a plurality of notches.

12. The ornamental light string as claimed in claim 9, wherein the first light-conducting element is a polyvinyl chloride (PVC) board with a plurality of dots.

13. The ornamental light string as claimed in claim 9, wherein the second light-conducting element is fiber optical bunches.

14. The ornamental light string as claimed in claim 9, wherein the third light-conducting element is fiber optical bunches.

15. The ornamental light string as claimed in claim 9, wherein the light-conducting tube is a transparent acrylic tube.
